(19) United States
(12) Patent Application Publication
(10) Pub. No.: US 2025/0280882 A1
(43) Pub. Date: Sep. 11, 2025

(54) ELECTRONIC ATOMIZATION DEVICE

(71) Applicant: SHENZHEN SMOORE TECHNOLOGY LIMITED, Shenzhen (CN)

(72) Inventors: Yubin XIAN, Shenzhen (CN); Huanxi LI, Shenzhen (CN); Lewen CHEN, Shenzhen (CN); Hongming ZHOU, Shenzhen (CN)

(21) Appl. No.: 19/219,459

(22) Filed: May 27, 2025

Related U.S. Application Data
(63) Continuation of application No. PCT/CN2023/123566, filed on Oct. 9, 2023.

(30) Foreign Application Priority Data
Nov. 28, 2022 (CN) 202223171651.6

(51) Int. Cl. A24F 40/46; A24F 40/42; A24F 40/57; H05B 7/101; H05H 1/48

(52) U.S. Cl. CPC A24F 40/46; A24F 40/42; A24F 40/57; H05B 7/101; H05H 1/48

(57) ABSTRACT

An electronic atomization device include: a substrate, a heating cavity being formed in the substrate; and an electrode assembly including a first electrode and a second electrode, both the first electrode and the second electrode at least partially extending into the heating cavity. In the heating cavity, an electric arc is controlled to form between the first electrode and the second electrode so as to generate plasma. Negative and positive polarities of the first electrode and the second electrode are switched in a preset cycle.

### CROSS-REFERENCE TO PRIOR APPLICATION

This application is a continuation of International Patent Application No. PCT/CN2023/123566, filed on Oct. 9, 2023, which claims priority to Chinese Patent Application No. 202223171651.6, filed on Nov. 28, 2022. The entire disclosure of both applications is hereby incorporated by reference herein.

### FIELD

This application relates to the field of atomization technologies, and in particular, to an electronic atomization device.

### BACKGROUND

An aerosol is a colloid dispersion system formed by solid or liquid small particles dispersed and suspended in a gas medium. Since aerosols can be absorbed by a human body through a respiratory system, a new alternative absorption manner is provided for users. For example, an atomization device that can produce the aerosol by baking and heating an aerosol-generating medium of a herbal type or an ointment type is provided, and the atomization device can be used in different fields to deliver an inhalable aerosol to the users, replacing a conventional product form and a conventional absorption manner.

Generally, the aerosol-generating medium is heated through an electronic atomization device. Some electronic atomization devices use a manner of plasmonic heating. Specifically, the manner of plasmonic heating is to place a high-voltage electrode and a low-voltage electrode in a heating element respectively, with the certain distance between the two electrodes. When a high voltage is loaded on the electrodes, an electric arc d plasma are generated in the gap, and heat generated by the plasma is used for heating.

However, when a direct current high-voltage power supply is used for discharging, since there is a temperature gradient of the plasma from the high-voltage electrode to the low-voltage electrode in the discharging gap, the heating element has a gradual temperature gradient along the axial direction, which is not conducive to the spatial uniformity of heating. In addition, since a negative electrode is bombarded by a positive ion in the plasma, the temperature of the negative electrode is significantly higher than the temperature of a positive electrode. Although a high-temperature resistant electrode material can slow down the ablation of the electrode to a certain extent, it is still easy for the electrode to be damaged and unable to discharge. Therefore, in a conventional manner of plasmonic heating, the spatial uniformity of heating is not good, and the electrodes are easily damaged.

### SUMMARY

In an embodiment, the present invention provides an electronic atomization device, comprising: a substrate, a heating cavity being formed in the substrate; and an electrode assembly comprising a first electrode and a second electrode, both the first electrode and the second electrode at least partially extending into the heating cavity, wherein, in the heating cavity, an electric arc is controlled to form between the first electrode and the second electrode so as to generate plasma, and wherein negative and positive polarities of the first electrode and the second electrode are switched in a preset cycle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization device according to an embodiment of this application;

FIG. 2 is a schematic diagram of modules of the electronic atomization device shown in FIG. 1;

FIG. 3 is a schematic structural diagram of an electronic atomization device according to another embodiment of this application; and

FIG. 4 is a partial schematic structural diagram of the electronic atomization device shown in FIG. 3.

### DETAILED DESCRIPTION

In an embodiment, the present invention provides an electronic atomization device to solve problems of poor spatial uniformity of plasmonic heating and easy damage of electrodes.

In an embodiment, the present invention provides an electronic atomization device. The electronic atomization device includes: a substrate, a heating cavity being formed in the substrate; and

an electrode assembly, including a first electrode and a second electrode, both the first electrode and the second electrode at least partially extending into the heating cavity, where

in the heating cavity, an electric arc is controlled to form between the first electrode and the second electrode, plasma is generated, and negative and positive polarities of the first electrode and the second electrode are switched in a preset cycle.

In the foregoing electronic atomization device, in the heating cavity, the electric arc can be controlled to form between the first electrode and the second electrode, and the plasma can be generated, so that the substrate is heated through the plasma generated by discharging between the first electrode and the second electrode, thereby heating and atomizing an aerosol-generating medium disposed on the substrate to form an aerosol for users to inhale.

In addition, the negative and positive polarities of the first electrode and the second electrode are switched in the preset cycle. In other words, in a period of time, the first electrode is a negative electrode and the second electrode is a positive electrode, and in another period of time, reverse switching is performed, the first electrode is the positive electrode, and the second electrode is the negative electrode. Such reverse switching enables the first electrode and the second electrode to be alternately used as the negative electrode, thereby preventing one of the first electrode and the second electrode from being ablated by the high temperature due to being the negative electrode for a long time and preventing the electrodes from being damaged and unable to discharge. In addition, the first electrode and the second electrode alternately have the negative and positive polarities, so that the negative electrode with the high temperature alternately appears on the first electrode and the second electrode. In this way, the substrate has the high temperature at one end for a period of time and the high temperature at the other end for another period of time. After switching for several times, the temperature of the entire substrate is more uniformly in space, and the substrate can more uniformly heat and atomize the aerosol-generating medium. In this way, the uniformity of a heating space heated by the plasma is better, and the electrodes are not easily damaged.

In an embodiment, the electronic atomization device includes a power supply assembly and a control assembly, where the control assembly is electrically connected between the power supply assembly and the electrode assembly, the power supply assembly is configured to provide a high-voltage alternating current, and the control assembly is configured to output a high-voltage direct current to the electrode assembly and switch the negative and positive polarities of the first electrode and the second electrode in the preset cycle.

In an embodiment, the power supply assembly includes a power supply module and a transformer, and the transformer is connected to the power supply module and is configured to output the high-voltage alternating current; and

the control assembly includes a rectifier and a switch control, the rectifier is electrically connected between the transformer and the switch control and is configured to integrate the high-voltage alternating current into a high-voltage direct current that flows to the switch control, both the first electrode and the second electrode are electrically connected to the switch control, and the switch control is configured to reversely switch the negative and positive polarities of the first electrode and the second electrode in the preset cycle.

In an embodiment, the substrate is constructed as a center heating structure inserted into an aerosol-generating medium, or the substrate is constructed as a peripheral heating structure surrounding the aerosol-generating medium.

In an embodiment, the substrate includes a tubular body, the tubular body includes the heating cavity, both the first electrode and the second electrode at least partially extend into the heating cavity, and end portions of the first electrode and the second electrode are disposed at an interval along the axial direction of the tubular body.

In an embodiment, the tubular body includes the top end and the bottom end that are opposite to each other along the axial direction of the tubular body, one of the first electrode and the second electrode whose end portion along the axial direction is located at the top end is a negative electrode in the initial polarity, and the other of the first electrode and the second electrode whose end portion along the axial direction is located at the bottom end is a positive electrode in the initial polarity.

In an embodiment, the tubular body includes an inner tubular body and an outer tubular body that is sleeved outside the inner tubular body at an interval, the heating cavity includes a first sub-cavity and a second sub-cavity that are in communication with each other, the first sub-cavity is disposed throughout the inner tubular body along the axial direction of the inner tubular body, and the second sub-cavity is defined between the top portion of the inner tubular body and the outer tubular body; and

one of the first electrode and the second electrode at least partially extends into the first sub-cavity, and the other of the first electrode and the second electrode at least partially extends into the second sub-cavity.

In an embodiment, one end of the first electrode extends into the first sub-cavity, the other end of the first electrode is located outside the first sub-cavity, the second electrode includes a body portion and a pin portion, the body portion is disposed in the second sub-cavity and is disposed opposite to the first electrode at an interval along the axial direction of the inner tubular body, and the pin portion is connected to the body portion and extends to the outside through the gap between the inner tubular body and the outer tubular body.

In an embodiment, the substrate includes a shell and an inner pot sleeved on the shell, the inner pot includes an accommodating cavity, the heating cavity is defined between the inner pot and the shell, and both the first electrode and the second electrode are mounted on the shell.

In an embodiment, one of the first electrode and the second electrode is disposed around the periphery of the inner pot, and the other of the first electrode and the second electrode is located at the center of the bottom portion of the inner pot; and

one of the first electrode and the second electrode that is at the center of the bottom portion of the inner pot is the negative electrode in the initial polarity, and the other of the first electrode and the second electrode that is around the periphery of the inner pot is the positive electrode in the initial polarity.

In an embodiment, the inner pot is detachably disposed on the shell.

Descriptions of referential numerals: 100: Atomizer; 10: Substrate; 11: Heating cavity; 112: First sub-cavity; 114: Second sub-cavity; 13: Accommodating cavity; 14: Tubular body; 141: Top end; 143: Bottom end; 145: Inner tubular body; 147: Outer tubular body; 16: Shell; 18: Inner pot; 30: Electrode assembly; 32: First electrode; 34: Second electrode; 341: Body portion; 343: Pin portion; 50: Power supply assembly; 52: Power supply module; 54: Transformer; 70: Control assembly; 72: Rectifier; 74: Switch control; and 80: Magnetic ring.

To make the foregoing objects, features, and advantages of this application clearer and easier to understand, the following further describes specific implementations of this application with reference to the accompanying drawings. In the following descriptions, many specific details are described to fully understand this application. However, this application can be implemented in many other manners different from those described herein. A person skilled in the art can make similar improvements without departing from the connotation of this application. Therefore, this application is not limited to the specific embodiments disclosed below.

In the descriptions of this application, it is to be understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, and “circumferential” are based on orientation or position relationships shown in the accompanying drawings, and are used only for ease of describing this application and simplifying the descriptions description, rather than indicating or implying that the mentioned device or component have to have a particular orientation or have to be constructed and operated in a particular orientation. Therefore, such terms cannot be construed as a limitation to this application.

In addition, terms “first” and “second” are merely for description, and cannot be understood as indicating or implying relative importance or implying a quantity of technical features indicated. Therefore, features defined by “first” and “second” may explicitly indicate or implicitly include at least one of such features. In the descriptions of this application, “a plurality of” means at least two, such as two or three, unless otherwise explicitly and specifically defined.

In this application, unless otherwise explicitly specified or defined, terms such as “mount”, “connected”, “connection”, and “fix” should be understood in a broad sense. For example, the connection may be a fixed connection, a detachable connection, or an integral connection; or the connection may be a mechanical connection, or an electrical connection; or the connection may be a direct connection, an indirect connection through an intermediary, or internal communication between two elements or a mutual action relationship between two elements, unless otherwise specified explicitly. A person of ordinary skill in the art may understand specific meanings of the foregoing terms in this application based on specific situations.

In this application, unless otherwise explicitly specified and defined, that a first feature is “above” or “below” a second feature may be that the first feature directly contacts with the second feature, or the first feature indirectly contacts with the second feature through an intermediary. In addition, that the first feature is “above”, “over”, or “on” the second feature may be that the first feature is directly above or obliquely above the second feature, or may merely indicate that the first feature is at a higher horizontal position than the second feature. That the first feature is “under”, “below”, and “on the bottom of” the second feature may be that the first feature is directly below or obliquely below the second feature, or may merely indicate that the first feature is at a lower horizontal position than the second feature.

It should be noted that, when an element is referred to as being “fixed to” or “disposed on” another element, the element may be directly on the another element, or there may be an intervening element. When an element is considered to be “connected to” another element, the element may be directly connected to the another element, or there may be an intervening element. The terms “vertical”, “horizontal”, “upper”, “lower”, “left”, “right”, and similar expressions used herein are merely intended for description, and do not indicate a unique implementation.

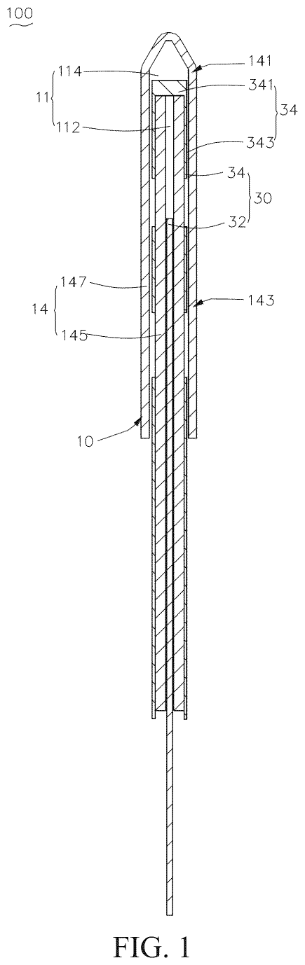

Referring to FIG. 1, in an embodiment of this application, an electronic atomization device 100 is provided and includes a substrate 10 and an electrode assembly 30. A heating cavity 11 is formed in the substrate 10, the electrode assembly 30 includes a first electrode 32 and a second electrode 34, and both the first electrode 32 and the second electrode 34 at least partially extend into the heating cavity 11. In the heating cavity 11, an electric arc can be controlled to form between the first electrode 32 and the second electrode 34, and plasma can be generated, so that the substrate 10 is heated through the plasma generated by discharging between the first electrode 32 and the second electrode 34, thereby heating and atomizing an aerosol-generating medium disposed on the substrate 10 to form an aerosol for users to inhale.

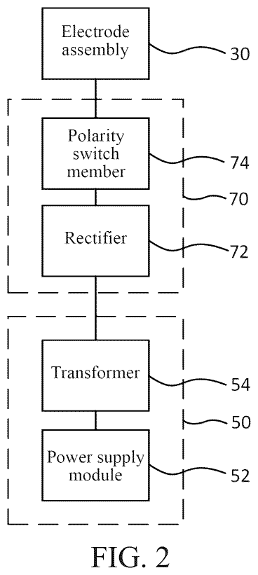

In addition, the negative and positive polarities of the first electrode 32 and the second electrode 34 are switched in a preset cycle. In other words, in a period of time, the first electrode 32 is a negative electrode and the second electrode 34 is a positive electrode, and in another period of time, reverse switching is performed, the first electrode 32 is the positive electrode, and the second electrode 34 is the negative electrode. Such reverse switching enables the first electrode 32 and the second electrode 34 to be alternately used as the negative electrode, thereby preventing one of the first electrode 32 and the second electrode 34 from being ablated by the high temperature due to being the negative electrode for a long time and preventing the electrodes from being damaged and unable to discharge. In addition, the first electrode 32 and the second electrode 34 alternately have the negative and positive polarities, so that the negative electrode with the high temperature alternately appears on the first electrode 32 and the second electrode 34. In this way, the substrate 10 has the high temperature at one end for a period of time and the high temperature at the other end for another period of time. After switching for several times, the temperature of the entire substrate 10 is more uniformly in space, and the substrate 10 can more uniformly heat and atomize the aerosol-generating medium. In this way, the uniformity of a heating space heated by the plasma is better, and the electrodes are not easily damaged. Referring to FIG. 2, further, the electronic atomization device 100 includes a power supply assembly 50 and a control assembly 70, the control assembly 70 is electrically connected between the power supply assembly 50 and the electrode assembly 30, the power supply assembly 50 is configured to provide a high-voltage alternating current, and the control assembly 70 is configured to output a high-voltage direct current to the electrode assembly 30 and switch the negative and positive polarities of the first electrode 32 and the second electrode 34 in the preset cycle. In this way, the control assembly 70 is electrically connected between the power supply assembly 50 and the electrode assembly 30, which can convert the high-voltage alternating current into the high-voltage direct current that flows to the electrode assembly 30 through the control assembly 70, and can further switch the negative and positive polarities in the preset cycle through the control assembly 70, so that the polarities of the first electrode 32 and the second electrode 34 change in cycle. It should be noted that, a switching duration of a cyclic switching may be set to a same duration, or may be set to different durations according to requirements, to achieve a regulated movement of a high-temperature region between the first electrode 32 and the second electrode 34 by adjusting a proportion of a duration in which the first electrode 32 or the second electrode 34 is used as the negative electrode.

Specifically, the power supply assembly 50 includes a power supply module 52 and a transformer 54. The transformer 54 is connected to the power supply module 52 and is configured to output the high-voltage alternating current, to step up a current by using the transformer 54. The control assembly 70 includes a rectifier 72 and a switch control 74, the rectifier 72 is electrically connected between the transformer 54 and the switch control 74 and is configured to integrate the high-voltage alternating current into a high-voltage direct current that flows to the switch control 74, both the first electrode 32 and the second electrode 34 are electrically connected to the switch control 74, and the switch control 74 is configured to reversely switch the negative and positive polarities of the first electrode 32 and the second electrode 34 in the preset cycle. In this way, the high-voltage alternating current outputted by the transformer 54 is converted into the high-voltage direct current through the rectifier 72, then the high-voltage direct current is outputted to the electrode assembly 30 through the switch control 74, and the polarities of the first electrode 32 and the second electrode 34 are switched in cycle through the switch control 74, so that the first electrode 32 and the second electrode 34 are intermittently used as the negative electrode, to prevent the first electrode 32 and the second electrode 34 from being used as the negative electrode and being burned at the high temperature for a long time. In addition, the high-temperature region corresponding to the negative electrode on the substrate 10 is constantly switched, and heating on the entire substrate 10 is more uniform.

Referring to FIG. 1, in some embodiments, the substrate 10 is constructed as a center heating structure inserted into the aerosol-generating medium. When the plasma is generated in the heating cavity 11 inside the substrate 10, the substrate 10 is heated, and the substrate 10 is inserted into the aerosol-generating medium, to transfer heat from the inside of the aerosol-generating medium, to heat and atomize the aerosol-generating medium.

Further, the substrate 10 includes a tubular body 14, the tubular body 14 includes the heating cavity 11, both the first electrode 32 and the second electrode 34 at least partially extend into the heating cavity 11, and end portions of the first electrode 32 and the second electrode 34 are disposed at an interval along the axial direction of the tubular body 14. In this way, the electric arc is formed inside the tubular body 14 along the axial direction of the tubular body 14, and the tubular body 14 is heated along the axial direction of the tubular body 14. During use, the aerosol-generating medium is inserted into the tubular body 14, so that the aerosol-generating medium can be heated from the inside to the outside through the tubular body 14.

Specifically, the tubular body 14 includes the top end 141 and the bottom end 143 that are opposite to each other along the axial direction of the tubular body 14, one of the first electrode 32 and the second electrode 34 whose end portion along the axial direction is located at the top end 141 is a negative electrode in the initial polarity, and the other of the first electrode 32 and the second electrode 34 whose end portion along the axial direction is located at the bottom end 143 is a positive electrode in the initial polarity. In this way, the negative electrode with the higher temperature is located at the top end 141, so that the high temperature region is closer to the top end 141, thereby improving an initial smoke output speed.

Specifically, in this embodiment, the tubular body 14 includes an inner tubular body 145 and an outer tubular body 147 that is sleeved outside the inner tubular body 145 at an interval, the heating cavity 11 includes a first sub-cavity 112 and a second sub-cavity 114 that are in communication with each other, the first sub-cavity 112 is disposed throughout the inner tubular body 145 along the axial direction of the inner tubular body 145, and the second sub-cavity 114 is defined between the top portion of the inner tubular body 145 and the outer tubular body 147. One of the first electrode 32 and the second electrode 34 at least partially extends into the first sub-cavity 112, and the other of the first electrode 32 and the second electrode 34 at least partially extends into the second sub-cavity 114. In this way, after the inner tubular body 145 and the outer tubular body 147 are sleeved to form the heating cavity 11, and the first electrode 32 and the second electrode 34 are disposed at an interval along the axial direction of the inner tubular body 145, the plasma can be controlled to at least form in the first sub-cavity 112 along the axial direction of the inner tubular body 145, to heat the tubular body 14 along the axial direction.

Further, one end of the first electrode 32 extends into the first sub-cavity 112, and the other end of the first electrode 32 is located outside the first sub-cavity 112 for circuit connection. The second electrode 34 includes a body portion 341 and a pin portion 343. The body portion 341 is disposed in the second sub-cavity 114, and is disposed opposite to the first electrode 32 at an interval along the axial direction of the inner tubular body 145. The pin portion 343 is connected to the body portion 341 and extends to the outside through the gap between the inner tubular body 145 and the outer tubular body 147, so that the second electrode 34 is connected to the circuit. In addition, the electric arc is generated in the first sub-cavity 112 along the axial direction through the first electrode 32 and the body portion 341 of the second electrode 34, to heat the tubular body 14.

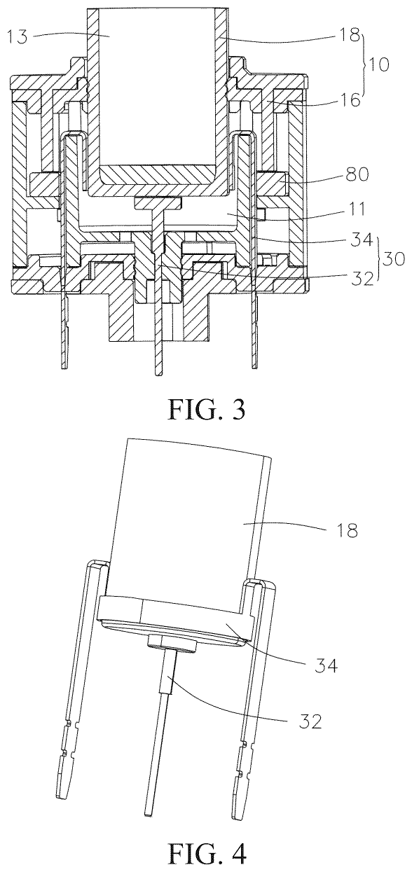

Referring to FIG. 3 and FIG. 4, in some other embodiments, the substrate 10 is constructed as a peripheral heating structure surrounding the aerosol-generating medium. In other words, the substrate 10 surrounds the aerosol-generating medium. The substrate 10 is heated when the plasma is generated in the heating cavity 11, and the substrate 10 heats, from the outside to the inside, the aerosol-generating medium surrounded by the substrate 10, thereby atomizing the aerosol-generating medium to form the aerosol for the users to inhale.

Further, the substrate 10 includes a shell 16 and an inner pot 18 sleeved on the shell 16. The inner pot 18 includes an accommodating cavity 13. The heating cavity 11 is defined between the inner pot 18 and the shell 16. Both the first electrode 32 and the second electrode 34 are mounted on the shell 16, and the first electrode 32 and the second electrode 34 can at least partially extend into the heating cavity 11 between the inner pot 18 and the shell 16, to heat the inner pot 18 after the electric arc and the plasma are generated in the heating cavity 11 by discharging, thereby heating and atomizing the aerosol-generating medium in the accommodating cavity 13 of the inner pot 18.

Specifically, one of the first electrode 32 and the second electrode 34 is disposed around the periphery of the inner pot 18, and the other of the first electrode 32 and the second electrode 34 is located at the center of the bottom portion of the inner pot 18. In this way, the electric arc formed between the first electrode 32 and the second electrode 34 may rotate around the entire periphery of the inner pot 18 based on driving of a magnetic field, to heat the entire periphery of the inner pot 18, so that a heating region is more uniform. Optionally, the second electrode 34 includes a discharging ring sleeved on the periphery of the inner pot 18. The electronic atomization device 100 further includes a magnetic ring 80 disposed on the shell 16 and sleeved on the periphery of the discharging ring, so that the arc is driven to rotate around the periphery of the discharging ring and in the heating cavity 11, to uniformly heat the inner pot 18 from the entire periphery of the inner pot 18 by using the magnetic ring 80.

In addition, one of the first electrode 32 and the second electrode 34 that is at the center of the bottom portion of the inner pot 18 is the negative electrode in the initial polarity, and the other of the first electrode 32 and the second electrode 34 that is around the periphery of the inner pot 18 is the positive electrode in the initial polarity. In this way, in an initial state, the temperature at the center of the bottom portion of the inner pot 18 is high, and the temperature at the bottom portion of the inner pot 18 is quickly concentrated, thereby shortening a smoke output duration in an initial stage and increasing the smoke output speed in the initial stage of atomization. Subsequently, after a requirement for rapid smoke output is satisfied, the polarities of the first electrode 32 and the second electrode 34 are reversely switched, so that one of the first electrode 32 and the second electrode 34 at the periphery of the inner pot 18 is the negative electrode, and the other of the first electrode 32 and the second electrode 34 at the center of the bottom portion of the inner pot 18 is the positive electrode. In this way, a temperature field at the periphery of the inner pot 18 is uniform, and the aerosol-generating medium can be uniformly heated.

It may be understood that, the polarities of the first electrode 32 and the second electrode 34 may be switched for a single time, or may be switched in cycle for several times. This is not limited herein.

Optionally, the inner pot 18 is detachably disposed on the shell 16. When the aerosol-generating medium is heated and atomized, the aerosol-generating medium is disposed in the accommodating cavity 13 of the inner pot 18, and the inner pot 18 is mounted on the shell 16. The heating cavity 11 is defined between the inner pot 18 and the shell 16. The electrode assembly 30 discharges in the heating cavity 11 to generate the electric arc and the plasma, to heat the inner pot 18 and the aerosol-generating medium in the inner pot 18 through the heat of the plasma. After the electronic atomization device 100 is used for a period of time, the inner pot 18 may be conveniently detached from the shell 16 for cleaning, to prevent, after the inner pot 18 is used for a long time, a residual in the inner pot 18 from affecting the atomization taste, thereby ensuring the atomization taste.

The technical features in the foregoing embodiments may be randomly combined. For concise descriptions, not all possible combinations of the technical features in the foregoing embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An electronic atomization device, comprising:
a substrate, a heating cavity being formed in the substrate; and
an electrode assembly comprising a first electrode and a second electrode, both the first electrode and the second electrode at least partially extending into the heating cavity,
wherein, in the heating cavity, an electric arc is controlled to form between the first electrode and the second electrode so as to generate plasma, and
wherein negative and positive polarities of the first electrode and the second electrode are switched in a preset cycle.

2. The electronic atomization device of claim 1, further comprising:
a power supply assembly; and
a control assembly,
wherein the control assembly is electrically connected between the power supply assembly and the electrode assembly,
wherein the power supply assembly is configured to provide a high-voltage alternating current, and
wherein the control assembly is configured to output a high-voltage direct current to the electrode assembly and switch the negative and positive polarities of the first electrode and the second electrode in the preset cycle.

3. The electronic atomization device of claim 2, wherein the power supply assembly comprises a power supply module and a transformer, the transformer is connected to the power supply module, the transformer being configured to output the high-voltage alternating current,
wherein the control assembly comprises a rectifier and a switch control, the rectifier is electrically connected between the transformer and the switch control, the rectifier being configured to integrate the high-voltage alternating current into a high-voltage direct current that flows to the switch control,
wherein both the first electrode and the second electrode are electrically connected to the switch control, and
wherein the switch control is configured to reversely switch the negative and positive polarities of the first electrode and the second electrode in the preset cycle.

4. The electronic atomization device of claim 1, wherein the substrate comprises a center heating structure inserted into an aerosol-generating medium, or
wherein the substrate comprises a peripheral heating structure surrounding the aerosol-generating medium.

5. The electronic atomization device of claim 4, wherein the substrate comprises a tubular body, the tubular body comprising the heating cavity,
wherein both the first electrode and the second electrode at least partially extend into the heating cavity, and
wherein end portions of the first electrode and the second electrode are disposed at an interval along an axial direction of the tubular body.

6. The electronic atomization device of claim 5, wherein the tubular body comprises a top end and a bottom end that are opposite to each other along the axial direction of the tubular body,
wherein one of the first electrode and the second electrode whose end portion along the axial direction is located at the top end comprises a negative electrode in the initial polarity, and
wherein an other of the first electrode and the second electrode whose end portion along the axial direction is located at the bottom end comprises a positive electrode in the initial polarity.

7. The electronic atomization device of claim 5, wherein the tubular body comprises an inner tubular body and an outer tubular body that is sleeved outside the inner tubular body at an interval,
wherein the heating cavity comprises a first sub-cavity and a second sub-cavity that are in communication with each other, the first sub-cavity being disposed throughout the inner tubular body along the axial direction of the inner tubular body, and the second sub-cavity being defined between the top portion of the inner tubular body and the outer tubular body,
wherein one of the first electrode and the second electrode at least partially extends into the first sub-cavity, and
wherein an other of the first electrode and the second electrode at least partially extends into the second sub-cavity.

8. The electronic atomization device of claim 7, wherein one end of the first electrode extends into the first sub-cavity,
wherein an other end of the first electrode is located outside the first sub-cavity,
wherein the second electrode comprises a body portion and a pin portion,
wherein the body portion is disposed in the second sub-cavity and is disposed opposite to the first electrode at an interval along the axial direction of the inner tubular body, and
wherein the pin portion is connected to the body portion and extends to an outside through a gap between the inner tubular body and the outer tubular body.

9. The electronic atomization device of claim 1, wherein the substrate comprises a shell and an inner pot sleeved on the shell,
wherein the inner pot comprises an accommodating cavity,
wherein the heating cavity is defined between the inner pot and the shell, and
wherein both the first electrode and the second electrode are mounted on the shell.

10. The electronic atomization device of claim 9, wherein one of the first electrode and the second electrode is disposed around a periphery of the inner pot, and
wherein an other of the first electrode and the second electrode is located at a center of a bottom portion of the inner pot, and
wherein one of the first electrode and the second electrode that is at the center of the bottom portion of the inner pot comprises the negative electrode in the initial polarity, and
wherein the other of the first electrode and the second electrode that is around the periphery of the inner pot comprises the positive electrode in the initial polarity.

11. The electronic atomization device of claim 10, wherein the inner pot is detachably disposed on the shell.
